(19) United States
(12) Patent Application Publication
(10) Pub. No.: US 2022/0261551 A1
(43) Pub. Date: Aug. 18, 2022

(54) MULTI-FACETED KNOWLEDGE-DRIVEN PRE-TRAINING FOR PRODUCT REPRESENTATION LEARNING

(71) Applicant: NEC Laboratories America, Inc., Princeton, NJ (US)

(72) Inventors: Yanchi Liu, Monmouth Junction, NJ (US); Bo Zong, West Windsor, NJ (US); Haifeng Chen, West Windsor, NJ (US); Xuchao Zhang, Elkridge, MD (US); Denghui Zhang, Urbana, IL (US)

(21) Appl. No.: 17/584,638

(22) Filed: Jan. 26, 2022

Related U.S. Application Data
(60) Provisional application No. 63/146,008, filed on Feb. 5, 2021.

(51) Int. Cl. G06F 40/30; G06F 40/284

(52) U.S. Cl. CPC G06F 40/30; G06F 40/284

(57) ABSTRACT

A method for employing a knowledge-driven pre-training framework for learning product representation is presented. The method includes learning contextual semantics of a product domain by a language acquisition stage including a context encoder and two language acquisition tasks, obtaining multi-faceted product knowledge by a knowledge acquisition stage including a knowledge encoder, skeleton attention layers, and three heterogeneous embedding guided knowledge acquisition tasks, generating local product representations defined as knowledge copies (KC) each capturing one facet of the multi-faceted product knowledge, and generating final product representation during a fine-tuning stage by combining all the KCs through a gating network.

### RELATED APPLICATION INFORMATION

This application claims priority to Provisional Application No. 63/146,008, filed on Feb. 5, 2021, the contents of which are incorporated herein by reference in their entirety.

### BACKGROUND

### Technical Field

The present invention relates to product representation learning and, more particularly, to multi-faceted knowledge-driven pre-training for product representation learning.

### Description of the Related Art

As a fundamental task in e-commerce, product representation learning (PRL) has been shown to benefit a wide range of applications, such as product matching, search, and categorization. Nonetheless, existing PRL approaches have difficulties in dealing with the polysemy problem due to the insufficient ability in capturing contextualized semantics. Also, the learned representations by existing methods lack transferability for use for new products.

### SUMMARY

A method for employing a knowledge-driven pre-training framework for learning product representation is presented. The method includes learning contextual semantics of a product domain by a language acquisition stage including a context encoder and two language acquisition tasks, obtaining multi-faceted product knowledge by a knowledge acquisition stage including a knowledge encoder, skeleton attention layers, and three heterogeneous embedding guided knowledge acquisition tasks, generating local product representations defined as knowledge copies (KC) each capturing one facet of the multi-faceted product knowledge, and generating final product representation during a fine-tuning stage by combining all the KCs through a gating network.

A non-transitory computer-readable storage medium comprising a computer-readable program for employing a knowledge-driven pre-training framework for learning product representation is presented. The computer-readable program when executed on a computer causes the computer to perform the steps of learning contextual semantics of a product domain by a language acquisition stage including a context encoder and two language acquisition tasks, obtaining multi-faceted product knowledge by a knowledge acquisition stage including a knowledge encoder, skeleton attention layers, and three heterogeneous embedding guided knowledge acquisition tasks, generating local product representations defined as knowledge copies (KC) each capturing one facet of the multi-faceted product knowledge, and generating final product representation during a fine-tuning stage by combining all the KCs through a gating network.

A system for employing a knowledge-driven pre-training framework for learning product representation is presented. The system includes a memory and one or more processors in communication with the memory configured to learn contextual semantics of a product domain by a language acquisition stage including a context encoder and two language acquisition tasks, obtain multi-faceted product knowledge by a knowledge acquisition stage including a knowledge encoder, skeleton attention layers, and three heterogeneous embedding guided knowledge acquisition tasks, generate local product representations defined as knowledge copies (KC) each capturing one facet of the multi-faceted product knowledge, and generate final product representation during a fine-tuning stage by combining all the KCs through a gating network.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram of an exemplary knowledge-driven pre-training framework for learning product representation, in accordance with embodiments of the present invention;

FIG. 2 is a block/flow diagram of an exemplary first stage (language acquisition) of a two-stage knowledge-driven pre-training framework, in accordance with embodiments of the present invention;

FIG. 3 is a block/flow diagram of an exemplary second stage (knowledge acquisition) of a two-stage knowledge-driven pre-training framework, in accordance with embodiments of the present invention;

FIG. 4 is a block/flow diagram of an exemplary enhanced knowledge-driven pre-training framework for product representation learning, in accordance with embodiments of the present invention;

FIG. 5 is a block/flow diagram of exemplary equations for employing a knowledge-driven pre-training framework for learning product representation, in accordance with embodiments of the present invention;

FIG. 6 is a block/flow diagram of an exemplary practical application for employing a knowledge-driven pre-training framework for learning product representation, in accordance with embodiments of the present invention;

FIG. 7 is a block/flow diagram of exemplary Internet-of-Things (IoT) sensors used to collect data/information for employing a knowledge-driven pre-training framework for learning product representation, in accordance with embodiments of the present invention.

FIG. 8 is an exemplary practical application for employing a knowledge-driven pre-training framework for learning product representation, in accordance with embodiments of the present invention;

FIG. 9 is an exemplary processing system for employing a knowledge-driven pre-training framework for learning product representation, in accordance with embodiments of the present invention; and

FIG. 10 is a block/flow diagram of an exemplary method for employing a knowledge-driven pre-training framework for learning product representation, in accordance with embodiments of the present invention.

### DETAILED DESCRIPTION OF PREFERRED EMBODIMENTS

E-commerce has become an indispensable part of people's lives. According to global sale statistics, e-commerce is responsible for around $3.5 trillion in 2019, and is expected to hit $4.9 trillion by 2021. Among numerous data mining approaches for e-commerce, product representation learning (PRL) serves as a fundamental task, which aims to learn the distributional representations in a latent space for thousands of products. The latent representations possess the merits of dimensionality reduction, automatic feature learning, etc., thereby having been applied in a variety of downstream tasks including product matching, search, and categorization.

Despite the prevalent use and benefits of PRL, most prior approaches suffer from two noteworthy limitations. One is insufficient ability in capturing contextualized semantics to deal with the polysemy problem. The meaning of a word may vary in different contexts. For instance, in one real example at Amazon.com, where the word “Monitor” appears in two different product titles, e.g., “Baby Monitor . . . ” and “Dell . . . Monitor.” The former refers to a webcam or camera while the latter is closer to a display or screen. Such case challenges the existing PRL approaches that borrow the intuition of word2vec to learn product semantics, as the static word embedding cannot model the word sense dynamically from the context. These approaches may generate similar representations for two distinct products because they share some words, while these words actually have very different meanings in two contexts. Another limitation is the lack of transferability from existing products to new products. Existing PRLs either train a fixed embedding for every existing product or train a neural network to generate product embeddings. However, they cannot generalize well to new products, especially Out-of-Distribution (OOD) samples. Yet, for many e-commerce platforms where high volumes of new items are offered for sale every day, stable and fast transferability is important to the success of reliable services.

More recently, pre-trained language models (PLMs) such as Bidirectional Encoder Representations from Transformers (BERT) and Generative Pre-trained Transformer 3 (GPT-3), also known as contextualized word embeddings, have achieved great success in a broad range of natural language processing tasks. In contrast to the traditional word embedding, PLMs can greatly alleviate the polysemy problem as they encode semantic knowledge into a transformer network, which takes a whole sequence as input and the word sense is conditioned on the entire context. Besides, the paradigm of pre-training and fine-tuning also enables better transferability for new data. Based on its merits, attempts are made to adapt PLMs to the scenario of PRL and generate deep contextualized product representations.

However, it is a non-trivial task due to the following challenges:

One challenge is highlighting the key information of a product under the PLM framework. A natural way of generating representation is to feed the product title into a PLM and average all embeddings from the last layer of the transformer. However, such flat representation lacks priority over key information of the content. Identifying key information (e.g., product type, accessories) of a product is important for humans to distinguish between different products, yet a difficult task for machines. Therefore, how to highlight the “main points” under the framework of PLM is important for accurate product representation learning.

Another challenge is incorporating multi-faceted knowledge into PLMs smoothly. E-commerce platforms like Amazon, eBay, and Walmart include heterogeneous product knowledge such as product brand, product category, associated products, etc. Recently, they have been used to enhance product representation and alleviate the vocabulary gap problem. For example, people who search for “Dell Monitor” may also be interested in “Docking Station” although they are not literally similar. However, directly incorporating product knowledge into PLMs by multi-task learning can cause two kinds of discrepancy issues, that is, Language and Knowledge Discrepancy, meaning, the discrepancy between language modeling and product knowledge preservation may cause discrepant optimizing direction for the underlying neural network and Intraknowledge Discrepancy, that is, multi-faceted product knowledge (e.g., attribute, category knowledge, etc.) is heterogeneous, thus causing dispersed training objectives.

Another challenge is handling the noise and sparsity issues of knowledge. In most cases, product knowledge in e-commerce websites relies on data contributed by retailers, and thus tends to be noisy and sparse. Specifically, it happens for several reasons, e.g., inconsistent word usage. Different retailers may use synonyms (e.g., hood, hoodie, hoody) or abbreviation (e.g., Chocolate vs. Choc) to refer to the same concept. Another reason is, e.g., missing attribute value. Retailers may not always list all structured fields including necessary attributes and categories. Yet another reason is, e.g., dynamic user influence. Some knowledge is purely driven by user behavior (e.g., product associations like co-buy), inevitability affected by outliers. The above issues can lead to noise in data and cause sparsity.

The exemplary embodiments address these challenges by proposing KINDLE, a Knowledge-drIven pre-trainiNg framework for proDuct representation LEarning. In general, KINDLE is novel in at least the following aspects. To highlight the key information of a product, the exemplary methods propose a hierarchical Skeleton Attention (SA) compatible with PLM to capture the main points. The exemplary embodiments extend the pre-training to two separate stages, e.g., language acquisition and knowledge acquisition, and use an extra knowledge encoder to preserve product knowledge alone. In this way, the exemplary methods alleviate the language and knowledge discrepancy issue. During pre-training, the knowledge encoder along with skeleton attention first generates local product representations, which capture individual knowledge facets.

Then the exemplary methods propose an input-aware gating network to fuse local representations into final representations during a fine-tuning stage. The input-aware gating network ensures automatically selecting relevant knowledge facets in different downstream tasks and mitigating the intra-knowledge discrepancy issue. To alleviate the noise and sparsity issues of product knowledge, the exemplary methods further employ heterogeneous embeddings instead of isolated class labels to represent knowledge elements for knowledge acquisition tasks. In this way the knowledge interrelatedness, e.g., label correlations, can be captured. Such interrelatedness of knowledge catalyzes self-calibration to its noise and sparsity, thus enabling a more robust learning process.

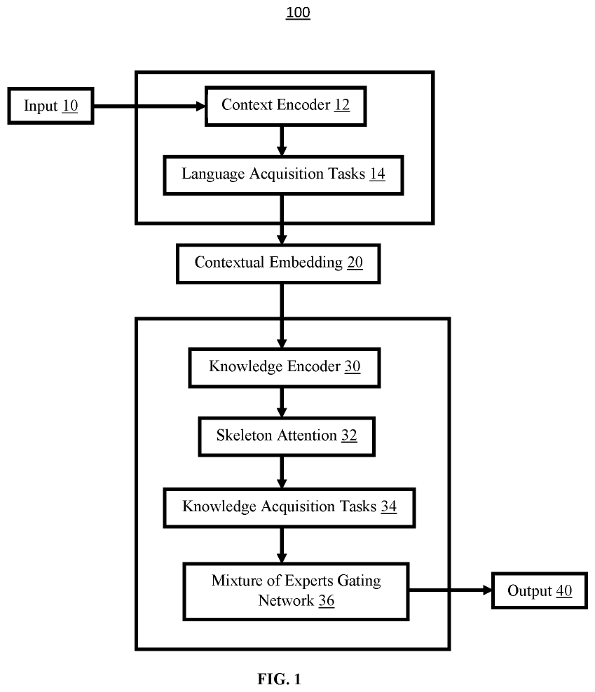

FIG. 1 is a block/flow diagram 100 of an exemplary knowledge-driven pre-training framework for learning product representation, in accordance with embodiments of the present invention.

The input 10 is provided to a context encoder 12 and language acquisitions tasks 14 of a language acquisition stage. Contextual embedding 20 is then performed in a knowledge acquisition stage including a knowledge encoder 30, skeleton attention layers 32, knowledge acquisition tasks 34, and a Mixture of Experts (MoE) gating network 36.

The output 40 is the final product representation.

Regarding the problem statement, given a product p represented by its title p={wᵢ}ᵢ₌₁ⁿ, the exemplary methods aim to learn a model [symbol] (based on PLMs) that maps p into a dense representation [symbol] (p), which encodes essential information. Following PLMs, the paradigm of pre-training and fine-tuning is adopted. During pre-training, multiple resources are leveraged to help [symbol] (p) encode product semantic information and additional multifaceted product knowledge. To apply it in downstream tasks such as product matching, search, classification, etc., [symbol] will further be fine-tuned on task-specific datasets to encode task-related knowledge.

Regarding multi-faceted product knowledge, the exemplary embodiments consider three facets of product knowledge and represent them by a Product Knowledge Graph (PKG). Three types of knowledge are loosely connected by a central product while inter-knowledge correlations are not presented. Besides, they differ vastly from each other in terms of volume and internal structure, thus being heterogeneous. Formal definitions are given below.

Regarding Neighbor Community Knowledge, given a product p in PKG, Eₚ={pᵢ}ᵢ₌₁^{m} is a set of surrounding products (similar or associated) as the neighbor community knowledge. Similar to social networks where a user can be learned through his/her friends, a product can also be depicted and enriched by its associated products.

Regarding Attribute Knowledge, given a product p in PKG, the corresponding attribute set is given as Aₚ={aᵢ}ᵢ₌₁^{l}, which is the attribute knowledge. The attribute knowledge provides more fine-grained semantic knowledge for product representations.

Regarding Category Knowledge, given a product p and a pre-defined category hierarchy [symbol] , the exemplary methods consider all categories it belongs to as the category knowledge, corresponding to nodes in [symbol] . The exemplary embodiments distinguish a category from attributes because there are rich structural correlations between different categories in [symbol] and such structural priors are preserved by optimizing latent category representations with Poincare Embedding.

In the following, the methodology is outlined in detail. An overview of the proposed KINDLE framework 200 is introduced and then, the details of the underlying components are presented.

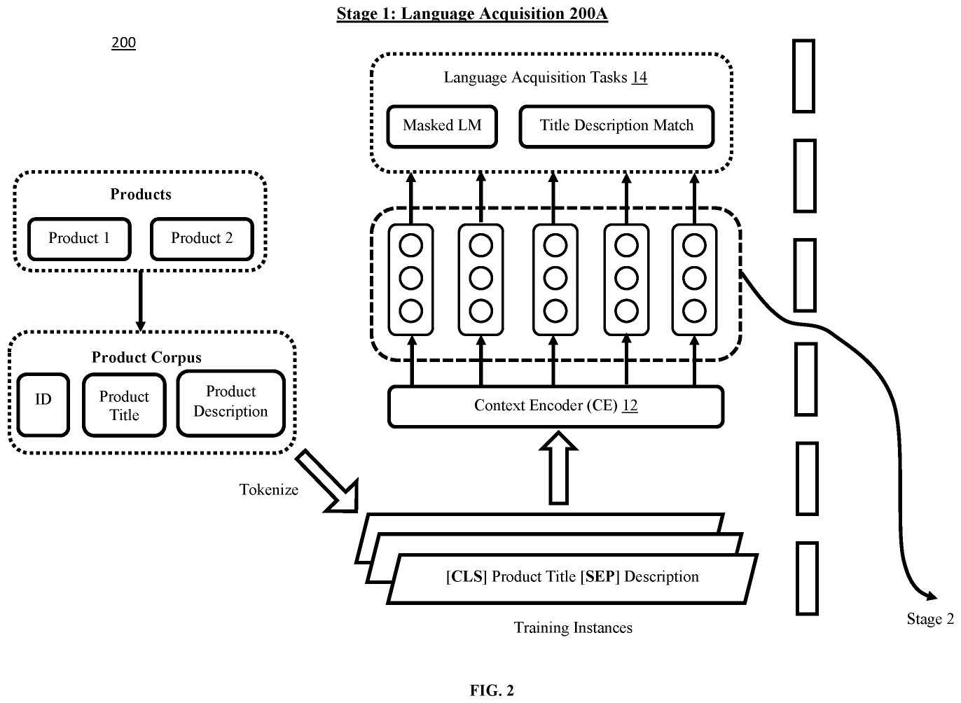

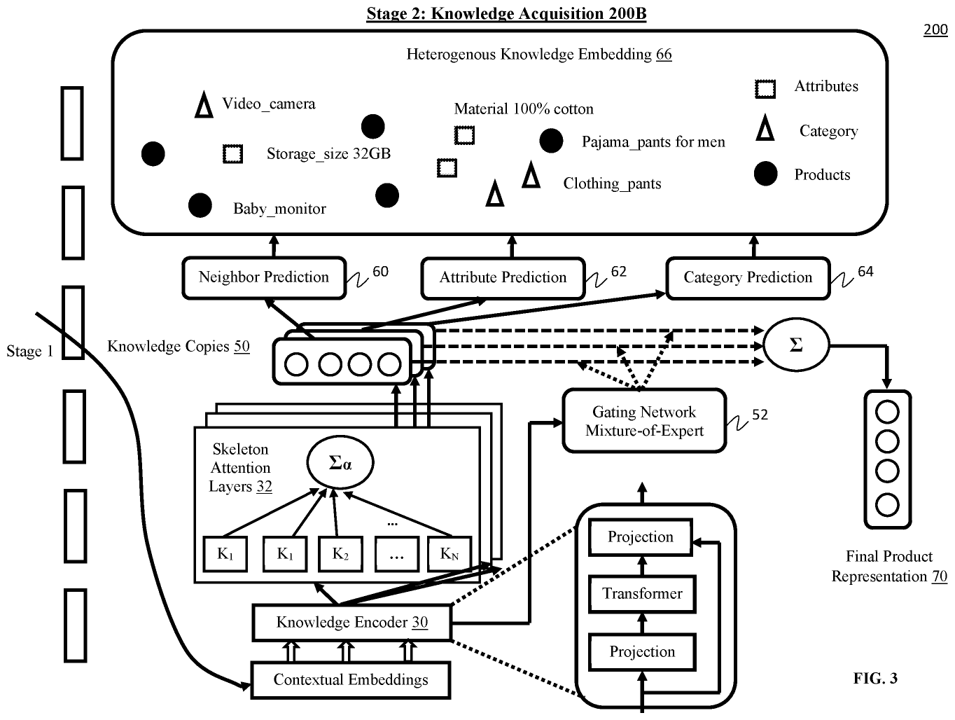

As shown in FIGS. 2-3, KINDLE 200 includes two sequential stages, that is, language acquisition 200A and knowledge acquisition 200B. In the first stage of pre-training, the exemplary methods rely on the language suite (including context encoder 12 and two language acquisition tasks 14) to learn contextual semantics of the product domain. In the second stage 200B, the context encoder 12 is fixed and its output is first transferred to the knowledge encoder (KE) 30. Then followed by multiple skeleton attention layers 32, local product representations are generated (e.g., knowledge copies (KCs) 50), each capturing one facet of product knowledge. KCs 50 are trained by heterogeneous embedding guided knowledge acquisition tasks to actually obtain multi-faceted knowledge. Final product representation 70 is generated during a fine-tuning stage by combining all KCs 50 through a gating network 52, which can adjust weights according to the input product content.

Regarding the language suite, the language suite serves for modeling contextual semantics, including input representation mapping, extended vocabulary, the context encoder 12, and two language acquisition tasks 14. The language suite is optimized only during the first stage 200A of pre-training.

Regarding input representation and vocabulary, given an input sequence (including a product title p={wᵢ}ᵢ₌₁ⁿ and description d={wᵢ}ᵢ₌₁^{m}), each word is first tokenized into smaller tokens (e.g., headphone→head, phone) and WordPiece embedding is used to generate token embeddings S={_{TOKi}}ᵢ₊₁^{n+m+2} (two special tokens [CLS] and [SEP] are inserted to the start and middle positions, respectively). For token vocabulary, BERT is employed since it is adopted as the backbone of the context encoder 12. To deal with novel words in the product domain, the vocabulary is expanded with 1000 of the most frequent out-of-vocabulary (OOV) words in the corpus by directly adding them as tokens. Finally, each token embedding is added with a position embedding and segment embedding to form the input representation S_{I}={Eᵢ}ᵢ₊₁^{n+m+2}.

Context Encoder (CE) 12 takes the tokenized, vectored input sequence and generates contextualized word embeddings. Pre-trained BERT is employed as the backbone to build CE 12 for two benefits, that is, inheriting rich language knowledge of BERT obtained from massive Wikipedia articles and easily adapting to the product domain and downstream tasks by post-training and adding task-specific layers.

Formally, given an initialized input sequence S_{I}={Eᵢ}ᵢ₊₁^{n+m+2}, the context encoder 12 maps S_{I} to the contextualized embedding sequence S_{T}={Tᵢ}ᵢ₌₁^{n+m+2}. While each internal layer of the context encoder 12 is empowered by self-attention, each output word embedding Tᵢ is dependent on the entire input sequence S_{I}={Eᵢ}ᵢ₌₁^{n+m+2}, where such design enables output embeddings to be “contextualized.”

Regarding language acquisition tasks 14, to preserve product semantics in CE 12, CE 12 is pre-trained by two language-acquisition tasks 14 as presented below.

With respect to Task 1, there is a Masked Language Model (MLM). MLM is a fill-in-the-blank task, where the model uses the context tokens around the mask token to try to predict predict what the mask token should be (e.g., “Baby [MASK] with Remote Pan-Tilt Zoom Camera” [symbol] “Monitor”). When it converges, the model learns contextual semantics of each token and the last layer of the transformer is considered as contextual embeddings. Given an input sequence, the exemplary methods randomly mask 15% of tokens and reconstruct them using the last layer.

With respect to Task 2, there is Title Description Matching (TDM). In addition to MLM, BERT uses the Next Sentence Prediction (NSP) task to enhance high-level semantic learning. The notion of the next sentence does not apply for the product corpus as the product title or description usually includes one sentence. Hence, the exemplary methods introduce TDM, a new sentence level task in which the global classification token ([CLS]) of the last layer is employed to predict whether the input product title matches the description (e.g., refers to the same product). Accordingly, the input is slightly modified during pre-training, e.g., the input product title is paired with its correct product description for 50% of the time (labeled as Match). And for the rest of the 50% of the time, the correct product description is replaced with a corrupted description that is randomly selected from a different category (labeled as NotMatch).

The objective function of TDM is summarized as:

$${q}_{i} = \frac{exp ( {T}_{CLS , i}^{T} {w}_{m} )}{1 + exp ( {T}_{CLS , i}^{T} {w}_{m} )}$$

$${ℒ}_{TDM} = - {\sum }_{i ∈ 𝒟} [ {y}_{i} log ( {q}_{i} ) + ( 1 - {y}_{i} ) log ( 1 - {q}_{i} ) ]$$

where wₘ is the parameter of binary classifier, qᵢ denotes the probability that the ith title and description match, yᵢ is the ground truth label (0 or 1) of matching, and [symbol] denotes the training corpus.

Regarding the knowledge suite, in the second stage 200B of pre-training, the knowledge suite preserves multi-faceted product knowledge, including a Knowledge Encoder 30, multiple Skeleton Attention layers 32, and three knowledge-acquisition tasks 60, 62, 64, as shown in FIG. 3. In the second stage 200B, only parameters of knowledge suite are optimized while the language networks are fixed. This ensures a smooth knowledge fusion without interfering with the language preserving function of PLM.

Regarding the knowledge encoder 30, the exemplary methods continue to use the product corpus as input fed into CE 12 and transfer the output to the knowledge encoder 30. It is noted that the exemplary methods do not update parameters of CE 12 in this process (stage 2). As shown in the bottom right-hand side of FIG. 3, knowledge encoder 30 includes two projection layers and multiple transformer layers. The projection layer aims to project input to “knowledge space” from “semantic space,” and the transformer layers store knowledge in the self-attentions and keep compatibility with CE 12. A skip connection is applied across two projection layers to avoid losing contextual embedding information. Only contextual embeddings of the product title (e.g., {Tᵢ}ᵢ₌₁ⁿ) are forwarded to knowledge encoder 30 to generate knowledge-informed embeddings (e.g., {Kᵢ}ᵢ₌₁ⁿ). The product description is disregarded because the title already includes the most necessary information, and the problem setting is using the title to represent a product, which is more applicable when online retailers do not provide product descriptions.

Regarding skeleton attention, to address the issue of highlighting key information of products, a novel attention method is proposed that is applied on the output of KE to generate intermediate product representations. The attention mechanism is featured with hierarchical structure and multi-faceted knowledge-guidance.

A two-layer hierarchical structure is used to form the attention, e.g., phrase-level and word-level attention. In this way, it automatically learns to attend informative phrases in the product title, as well as informative words in phrases, e.g., what is considered as the “skeleton” of a product.

Multiple duplicates of the attention layer are leveraged to generate intermediate representations, called Knowledge Copies (KCs). Each representation is pre-trained with a knowledge acquisition task, and thus the corresponding attention weights are guided by one facet of product knowledge, and multi-faceted knowledge is stored in different duplicates of the attention.

Regarding word-level attention, given the embeddings generated by KE (e.g., {Kᵢ}ᵢ₌₁ⁿ), corresponding to words in product title, the first layer of skeleton attention is the word-level attention, which learns an attention score over each word within a phrase. Specifically, a phrase boundary index is obtained by chunking product titles into phrases. Then within each phrase, attention is calculated over each word as:

$${u}_{ij} = tanh ( {W}_{w} {K}_{ij} + {b}_{w} )$$

$${α}_{ij} = \frac{exp ( {u}_{ij}^{T} {h}_{w} )}{{\sum }_{{k}^{′}} exp ( {u}_{{ij}^{′}}^{T} {h}_{w} )} , {v}_{i} = {\sum }_{k} {α}_{ij} {K}_{ij}$$

where Kᵢⱼ denotes the embedding of the jth word in the ith phrase, such that it is first fed through a one-layer perceptron to get uᵢⱼ as a hidden representation. Next, the importance of the word is measured as the correlation between uᵢⱼ and a word-level latent embedding h_{w}. Then a normalized importance (attention) weight αᵢⱼ is obtained through a softmax function. h_{w} is randomly initialized and jointly learned during the training process. Finally, the phrase embedding vⱼ is computed by summing up all the words (e.g., {K₁ⱼ, K₂ⱼ, . . . }) within it based on the attention weights.

Regarding phrase-level attention, after the intermediate phrase embeddings are obtained for phrases in the product title, the local product representations are obtained in a similar way:

$${u}_{i} = tanh ( {W}_{v} {v}_{i} + {b}_{v} )$$

$${β}_{i} = \frac{exp ( {u}_{i}^{T} {h}_{p} )}{{\sum }_{k} exp ( {u}_{k}^{T} {h}_{p} )} , p = {\sum }_{i} {β}_{i} {v}_{i}$$

where the phrase embedding vᵢ is first fed through a one-layer MLP to get uᵢ as a hidden representation of vᵢ. Then the importance of the phrase is measured as the correlation between uᵢ and the phrase-level latent embedding hₚ, and a normalized importance score βᵢ is obtained through a softmax function. Finally, the product embedding p is computed as a weighted sum of the phrase embeddings (e.g., {v₁, v₂, . . . }) based on the attention weights.

Regarding local representations, three duplicates of the skeleton attention are leveraged to generate three local representations (e.g., p₁, p₂, p₃), which are also referred to as “Knowledge Copies” as they are guided by three knowledge acquisition tasks to obtain corresponding knowledge.

Regarding heterogeneous knowledge embeddings 66, to overcome the sparsity and noise issues of product knowledge, as shown in FIG. 3, a heterogeneous embedding model is provided to represent them (e.g., let n, a, c denote the embeddings of neighbor products, attributes, and categories, respectively). During knowledge acquisition, compared to representing knowledge elements as isolated class labels, applying the knowledge embedding ensures preserving the label correlation and helps automatically calibrate noise and sparsity. Specifically, the exemplary methods propose three intuitions for optimizing the embeddings.

With respect to Intuition 1, products that share similar attributes, categories should be close in the embedding space. This intuition helps alleviate the noise issue in product associations which are generated from user behaviors, e.g., making truly associated products close to each other.

With respect to Intuition 2, attributes, categories that cover similar sets of products should be close in the embedding space. The intuition helps mitigate the synonym and missing value issues. For example, for chocolate products, two retailers may use “Chocolate” and “Choc” as the category name respectively, but as long as two synonyms cover similar sets of products, their embeddings will be close.

With respect to Intuition 3, category embeddings should preserve the hierarchical structure information. As mentioned previously, there are rich structural correlations among categories, where preserving such information improves category representations.

To fulfil the above intuitions, three objective functions are proposed, respectively, and they are jointly optimized:

$${𝒪}_{1} = {\sum }_{( {n}_{i} , {a}_{j} ) ∈ {𝒢}_{P}} {\sum }_{( {n}_{i} , {c}_{j} ) ∈ {𝒢}_{P}} log p ( {a}_{j} \vert {n}_{i} ) + log p ( {c}_{j} \vert {n}_{i} )$$

$${𝒪}_{2} = {\sum }_{( {n}_{i} , {a}_{j} ) ∈ {𝒢}_{P}} {\sum }_{( {n}_{i} , {c}_{j} ) ∈ {𝒢}_{P}} log p ( {n}_{j} \vert {a}_{i} ) + log p ( {n}_{j} \vert {c}_{i} )$$

$$log σ ( {n}_{j}^{T} {a}_{i} ) + {\sum }_{z = 1}^{Z} {𝔼}_{{n}_{l} \sim {P}_{n} ( n )} [ log σ ( - {n}_{l}^{T} {a}_{i} ) ]$$

where p(nⱼ|aᵢ)=exp(nⱼ^{T}aᵢ)/ [symbol] exp(n_{j′}^{T}aᵢ) denotes the probability of product nⱼ given attribute aᵢ, and it follows second-order proximity in network embedding. [symbol] _{P} denotes the product knowledge graph and [symbol] denotes the product set.

The exemplary methods calculate p(aⱼ|nᵢ), p(aⱼ|cᵢ), p(cⱼ|aᵢ) in the same way.

For efficient optimization, p(nⱼ|aᵢ) is replaced with:

$${𝒪}_{3} = {\sum }_{i ∈ 𝒞} {\sum }_{j ∈ child ( i )} p ( {c}_{j} \vert {c}_{i} )$$

That is, using negative sampling to approximate the original softmax function, and σ(x)=1/(1+exp(−x)) is the sigmoid function.

$$p ( {c}_{j} \vert {c}_{i} ) = \frac{exp ( - {d}_{Pointcaré} ( {c}_{j} , {c}_{i} ) )}{{\sum }_{c ∈ 𝒞} exp ( - {d}_{Pointcaré} ( {c}_{j} , {c}_{i} ) )}$$

$${d}_{Pointcaré} ( {c}_{j} , {c}_{i} ) = arcosh ( 1 + 2 \frac{{‖ {c}_{i} - {c}_{j} ‖}^{2}}{( 1 - {‖ {c}_{i} ‖}^{2} ) ( 1 - {‖ {c}_{j} ‖}^{2} )} )$$

[symbol] ₃ optimizes the distances of all parent-child category pairs, where p(cᵢ|cⱼ) denotes a softmax normalized distance of cⱼ and cᵢ.

d_{Pointcare′}( [symbol] ) denotes the distance metric used in Pointcare′ embedding which is the key to preserve structural correlations.

The exemplary methods leverage a multi-task learning strategy to jointly maximize [symbol] ₁, [symbol] ₂, [symbol] ₃, by sampling each task based on the size of the task data.

Regarding knowledge acquisition tasks, in the second pre-training stage, the exemplary methods train KCs 50 (e.g., p₁, p₂, p₃) with three knowledge acquisition tasks 60, 62, 64, e.g., Neighbor Prediction 60, Attribute Prediction 62, and Category Prediction 64. For each task, the corresponding pre-trained knowledge embeddings are used as target labels, and a hinge loss of distance between KCs 50 and their labels is optimized.

For instance, Neighbor Prediction task 60 is defined as:

$$\\ {ℒ}_{NP} = - {\sum }_{i ∈ 𝒟} {\sum }_{j ∈ N ( i )} max ( 0 , 1 + 〈 {p}_{1 , i} , {n}_{j} 〉 - 〈 {p}_{1 , i} , {n}_{j}^{-} 〉 )$$

where p_{1,i} denotes the generated first KC (knowledge copy) of the ith input product, [symbol] denotes the corpus, N(i) denotes the neighbor products of i, nⱼ represents the pre-trained embedding for neighbor product j, and n_{j̅} is a random negative sample. [symbol] denotes the L2 distance. It is noted that only KCs and the knowledge suite are updated while knowledge embeddings (nⱼ) are fixed. For the tasks of Attribute Prediction and Category Prediction, similarly, the exemplary methods calculate [symbol] _{AP} and [symbol] _{CP} for p₂, p₃ by replacing nⱼ with a₁ and cⱼ, respectively.

Regarding the final representation by mixtures of experts (MoE), given the knowledge-guided local representations p₁, p₂, p₃, it is proposed to combine them coherently to generate the final product representation 70. The intuition is that the same type of knowledge may have different gain effect in different instances of the product (e.g., for those products that already include attribute information like “Material 100% cotton” in title, attribute knowledge may bring limited improvements), and that the same knowledge may contribute differently (more or less) to different downstream tasks. The MoE model is employed to fulfil the three intuitions stated above.

As shown in FIGS. 2-3, a softmax gating network 52 is applied on the output of Knowledge Encoder 30 ([CLS] token) to calculate three normalized scalars g₁, g₂, g₃, which are then used as the weights summing KCs 50:

$${g}_{i} = \frac{exp ( {η}_{i}^{T} {K}_{CLS} )}{{\sum }_{j} exp ( {η}_{j}^{T} {K}_{CLS} )} \approx p ( {p}_{i} \vert η , {K}_{CLS} ) , i = 1 , 2 , 3$$

where ηᵢ denotes the gating parameter for the ith knowledge copy, K_{CLS} denotes the output [CLS] token of KE, and ηᵢ and K_{CLS} have the same dimensions. Final product representation p is calculated as a weighted sum of the gated local representations, e.g., p=Σᵢ₌₁³gᵢpᵢ. It is noted that, in the pre-training stage, only parameters behind p₁, p₂, p₃ are optimized, while parameters related top are fixed. That is, the exemplary methods only calculate the final representation p and update other parameters during the fine-tuning stage.

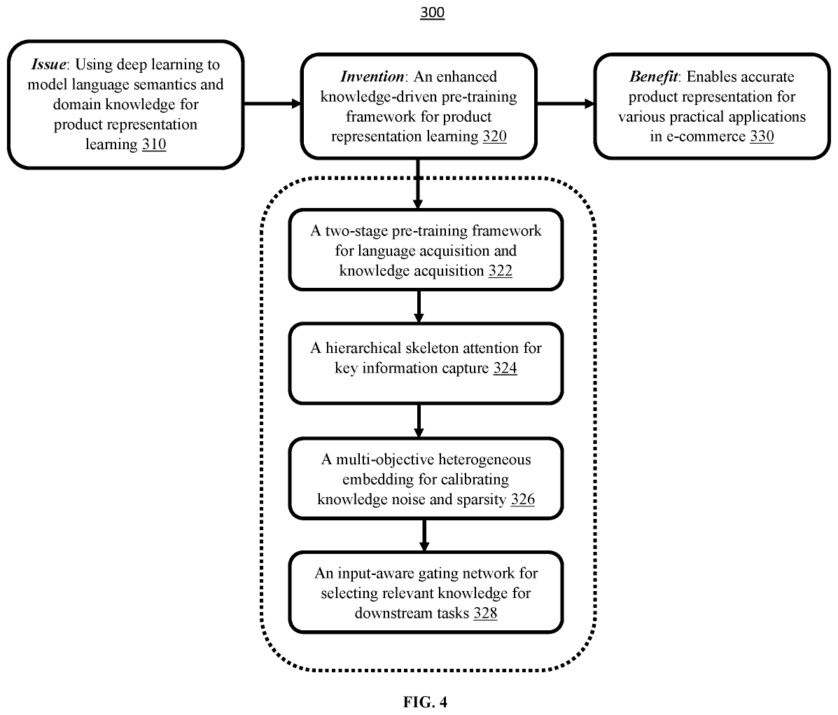

FIG. 4 is a block/flow diagram 300 of an exemplary enhanced knowledge-driven pre-training framework for product representation learning, in accordance with embodiments of the present invention.

The main issue 310 is using deep learning to model language semantics and domain knowledge for product representation learning.

The exemplary embodiments present a method and system 320 where an enhanced knowledge-driven pre-training framework is employed for product representation learning.

This is accomplished by block 322 including a two-stage pre-training framework for language acquisition and knowledge acquisition, by block 324 including a hierarchical skeleton attention for key information capture, block 326 including a multi-objective heterogeneous embedding for calibrating knowledge noise and sparsity, and block 328 including an input-aware gating network for selecting relevant knowledge for downstream tasks.

The benefits 330 include at least enabling accurate product representation for various practical applications in e-commerce.

Therefore, the exemplary embodiments introduce KINDLE, a Knowledge-drIven pre-trainiNg framework for proDuct representation LEarning, which can preserve the contextual semantics and multi-faceted product knowledge robustly and flexibly. Specifically, pre-training is extended to language acquisition and knowledge acquisition stages separately, and a deliberate knowledge encoder is exploited for ensuring a smooth knowledge fusion into PLM without interfering with its original function. Then, a hierarchical skeleton attention compatible with PLM is introduced to capture the key information of a product. In addition, a multi-objective heterogeneous embedding is provided to represent thousands of knowledge elements. This helps KINDLE calibrate knowledge noise and sparsity automatically by replacing isolated classes as training labels in knowledge acquisition. Also, an input-aware gating network is provided to automatically select the most relevant knowledge for different downstream tasks.

To highlight the key information of a product, a hierarchical skeleton attention is provided that is compatible with PLM to capture the main points.

Pre-training includes two separate stages, e.g., language acquisition and knowledge acquisition, and an extra knowledge encoder is used to preserve product knowledge. In this way, the language and knowledge discrepancy issues can be alleviated.

During pre-training, the knowledge encoder along with skeleton attention first generates local product representations, which capture individual knowledge facets. Then an input-aware gating network is provided to fuse local representations into final representations during a fine-tuning stage. It ensures automatically selecting relevant knowledge facets in different downstream tasks and mitigating the intra-knowledge discrepancy issue.

To alleviate the noise and sparsity issues of product knowledge, heterogeneous embeddings are used instead of isolated class labels to represent knowledge elements for knowledge acquisition tasks. In this way the knowledge interrelatedness, e.g., label correlations, can be captured. Such interrelatedness of knowledge catalyzes self-calibration to its noise and sparsity, thus enabling a more robust learning process.

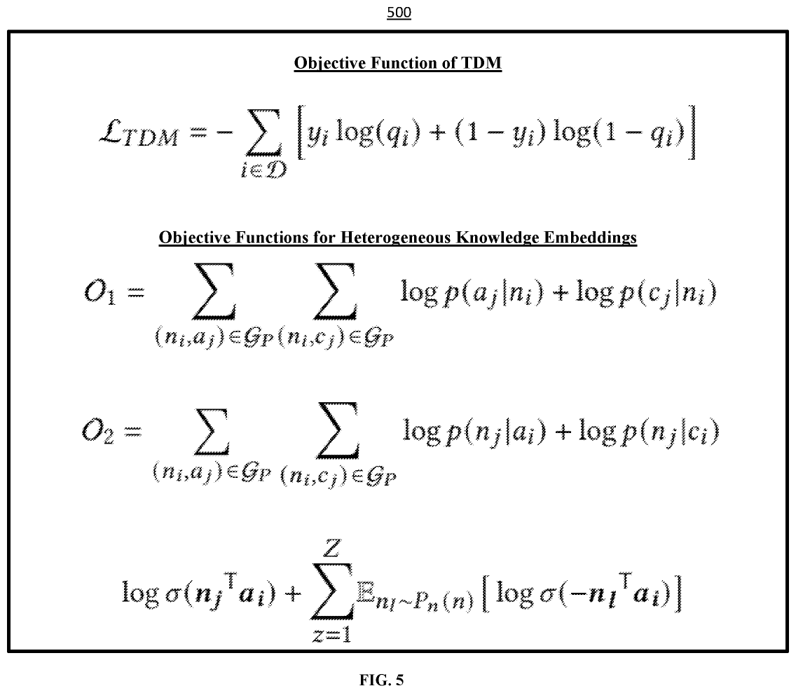

FIG. 5 is a block/flow diagram of exemplary equations for employing a knowledge-driven pre-training framework for learning product representation, in accordance with embodiments of the present invention.

Equations 500 include an objective function of the TDM and objective functions for the heterogeneous knowledge embeddings.

In conclusion, the exemplary embodiments of the present invention introduce KINDLE, which can preserve the contextual semantics and multi-faceted product knowledge robustly and flexibly. Specifically, pre-training is extended to language acquisition and knowledge acquisition stages 200A, 200B, separately, and a deliberate knowledge encoder is exploited for ensuring a smooth knowledge fusion into PLM without interfering with its original function. Then, a hierarchical skeleton attention compatible with PLM is introduced to capture the key information of a product. In addition, a multi-objective heterogeneous embedding is provided to represent thousands of knowledge elements. This helps KINDLE calibrate knowledge noise and sparsity automatically by replacing isolated classes as training labels in knowledge acquisition. Also, an input-aware gating network is provided to automatically select the most relevant knowledge for different downstream tasks.

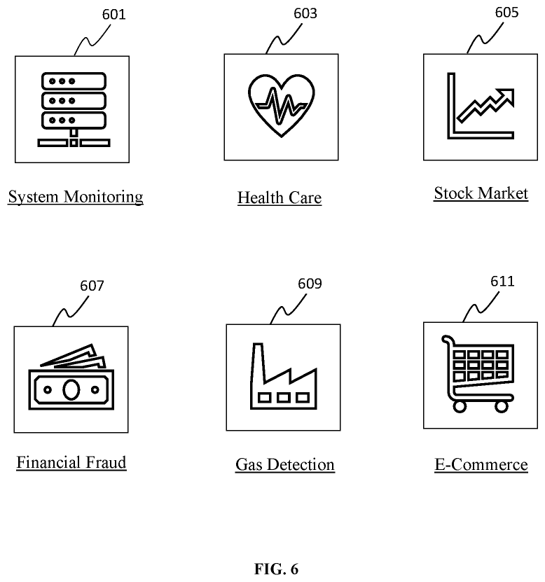

FIG. 6 is a block/flow diagram of an exemplary practical application for employing a knowledge-driven pre-training framework for learning product representation, in accordance with embodiments of the present invention.

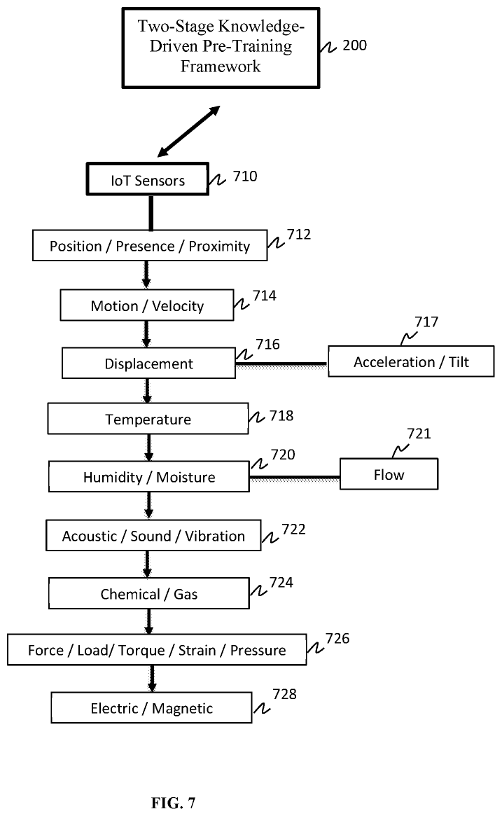

Practical applications for learning and forecasting trends in multivariate time series data can include, but are not limited to, system monitoring 601, healthcare 603, stock market data 605, financial fraud 607, gas detection 609, and e-commerce 611. The time-series data in such practical applications can be collected by sensors 710 (FIG. 7).

FIG. 7 is a block/flow diagram of exemplary Internet-of-Things (IoT) sensors used to collect data/information for employing a knowledge-driven pre-training framework for learning product representation, in accordance with embodiments of the present invention.

IoT loses its distinction without sensors. IoT sensors act as defining instruments which transform IoT from a standard passive network of devices into an active system capable of real-world integration.

The IoT sensors 710 can communicate with the two-stage knowledge-driven pre-training framework (or KINDLE 200) to process information/data, continuously and in in real-time. Exemplary IoT sensors 710 can include, but are not limited to, position/presence/proximity sensors 712, motion/velocity sensors 714, displacement sensors 716, such as acceleration/tilt sensors 717, temperature sensors 718, humidity/moisture sensors 720, as well as flow sensors 721, acoustic/sound/vibration sensors 722, chemical/gas sensors 724, force/load/torque/strain/pressure sensors 726, and/or electric/magnetic sensors 728. One skilled in the art can contemplate using any combination of such sensors to collect data/information for input into the two-stage knowledge-driven pre-training framework 200 for further processing. One skilled in the art can contemplate using other types of IoT sensors, such as, but not limited to, magnetometers, gyroscopes, image sensors, light sensors, radio frequency identification (RFID) sensors, and/or micro flow sensors. IoT sensors can also include energy modules, power management modules, RF modules, and sensing modules. RF modules manage communications through their signal processing, WiFi, ZigBee®, Bluetooth®, radio transceiver, duplexer, etc.

Moreover data collection software can be used to manage sensing, measurements, light data filtering, light data security, and aggregation of data. Data collection software uses certain protocols to aid IoT sensors in connecting with real-time, machine-to-machine networks. Then the data collection software collects data from multiple devices and distributes it in accordance with settings. Data collection software also works in reverse by distributing data over devices. The system can eventually transmit all collected data to, e.g., a central server.

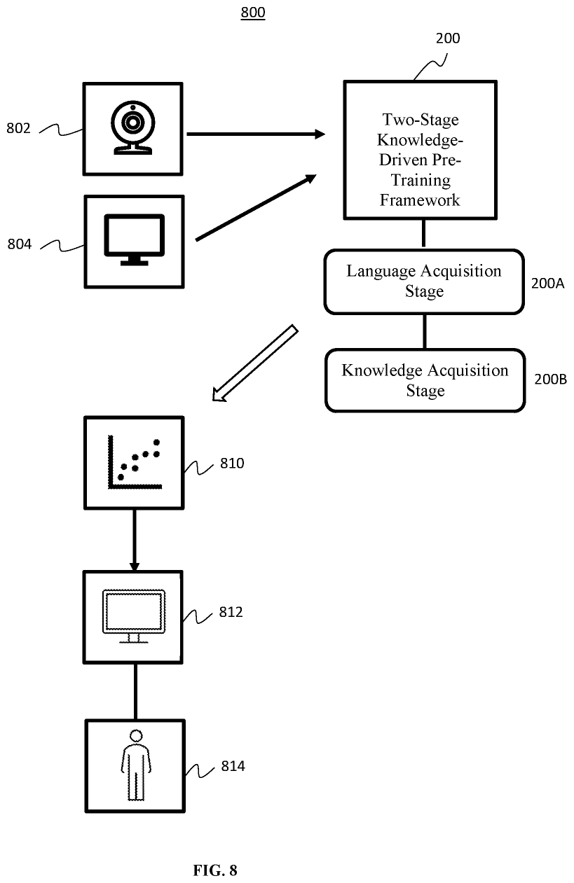

FIG. 8 is a block/flow diagram 800 of a practical application for employing a knowledge-driven pre-training framework for learning product representation, in accordance with embodiments of the present invention.

In one practical example, a first product 802 and a second product 804 can be obtained as a result of a search. Features extracted from the products 802, 804 are processed by the two-stage knowledge-driven pre-training framework 200 by employing a language acquisition stage 200A and a knowledge acquisition stage 200B. The results 810 (e.g., variables or parameters or factors) can be provided or displayed on a user interface 812 handled by a user 814.

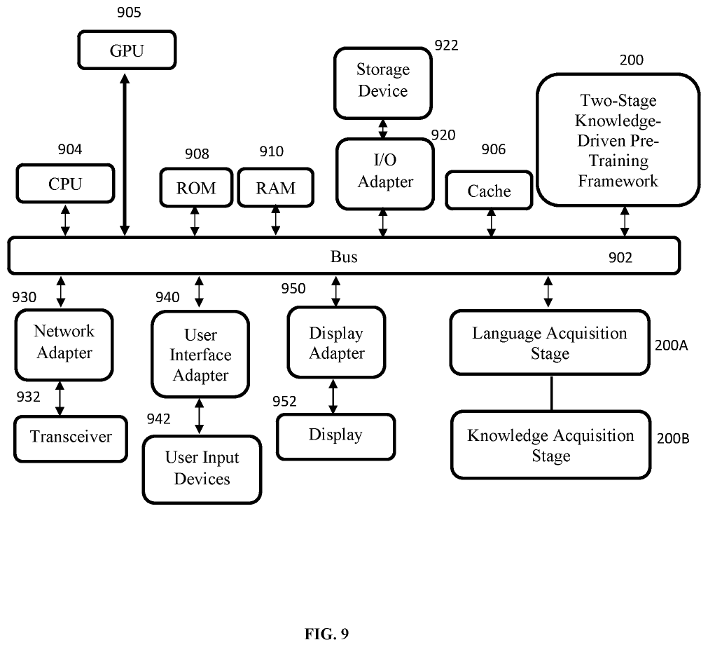

FIG. 9 is an exemplary processing system for employing a knowledge-driven pre-training framework for learning product representation, in accordance with embodiments of the present invention.

The processing system includes at least one processor (CPU) 904 operatively coupled to other components via a system bus 902. A GPU 905, a cache 906, a Read Only Memory (ROM) 908, a Random Access Memory (RAM) 910, an input/output (I/O) adapter 920, a network adapter 930, a user interface adapter 940, and a display adapter 950, are operatively coupled to the system bus 902. Additionally, the two-stage knowledge-driven pre-training framework 200 can be employed by a language acquisition stage 200A and a knowledge acquisition stage 200B.

A storage device 922 is operatively coupled to system bus 902 by the I/O adapter 920. The storage device 922 can be any of a disk storage device (e.g., a magnetic or optical disk storage device), a solid-state magnetic device, and so forth.

A transceiver 932 is operatively coupled to system bus 902 by network adapter 930.

User input devices 942 are operatively coupled to system bus 902 by user interface adapter 940. The user input devices 942 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 942 can be the same type of user input device or different types of user input devices. The user input devices 942 are used to input and output information to and from the processing system.

A display device 952 is operatively coupled to system bus 902 by display adapter 950.

Of course, the processing system may also include other elements (not shown), as readily contemplated by one of skill in the art, as well as omit certain elements. For example, various other input devices and/or output devices can be included in the system, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system are readily contemplated by one of ordinary skill in the art given the teachings of the present invention provided herein.

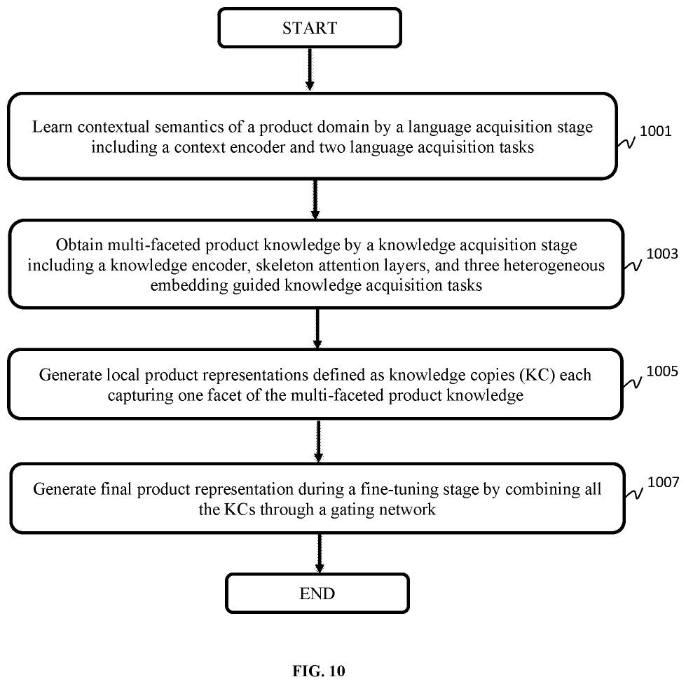

FIG. 10 is a block/flow diagram of an exemplary method for employing a knowledge-driven pre-training framework for learning product representation, in accordance with embodiments of the present invention.

At block 1001, learn contextual semantics of a product domain by a language acquisition stage including a context encoder and two language acquisition tasks.

At block 1003, obtain multi-faceted product knowledge by a knowledge acquisition stage including a knowledge encoder, skeleton attention layers, and three heterogeneous embedding guided knowledge acquisition tasks.

At block 1005, generate local product representations defined as knowledge copies (KC) each capturing one facet of the multi-faceted product knowledge.

At block 1007, generate final product representation during a fine-tuning stage by combining all the KCs through a gating network.

As used herein, the terms “data,” “content,” “information” and similar terms can be used interchangeably to refer to data capable of being captured, transmitted, received, displayed and/or stored in accordance with various example embodiments. Thus, use of any such terms should not be taken to limit the spirit and scope of the disclosure. Further, where a computing device is described herein to receive data from another computing device, the data can be received directly from the another computing device or can be received indirectly via one or more intermediary computing devices, such as, for example, one or more servers, relays, routers, network access points, base stations, and/or the like. Similarly, where a computing device is described herein to send data to another computing device, the data can be sent directly to the another computing device or can be sent indirectly via one or more intermediary computing devices, such as, for example, one or more servers, relays, routers, network access points, base stations, and/or the like.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” “calculator,” “device,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical data storage device, a magnetic data storage device, or any suitable combination of the foregoing. In the context of this document, a computer readable storage medium may be any tangible medium that can include, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks or modules.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks or modules.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks or modules.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for employing a knowledge-driven pre-training framework for learning product representation, the method comprising:
learning contextual semantics of a product domain by a language acquisition stage including a context encoder and two language acquisition tasks;
obtaining multi-faceted product knowledge by a knowledge acquisition stage including a knowledge encoder, skeleton attention layers, and three heterogeneous embedding guided knowledge acquisition tasks;
generating local product representations defined as knowledge copies (KC) each capturing one facet of the multi-faceted product knowledge; and
generating final product representation during a fine-tuning stage by combining all the KCs through a gating network.

2. The method of claim 1, wherein the KCs are trained by the three heterogeneous embedding guided knowledge acquisition tasks to obtain the multi-faceted product knowledge.

3. The method of claim 1, wherein the three heterogeneous embedding guided knowledge acquisition tasks are neighbor prediction, attribute prediction, and category prediction.

4. The method of claim 1, wherein the two language acquisition tasks include a masked language model (MLM) and title description matching (TDM).

5. The method of claim 4, wherein the MLM is a fill-in-the-blank task where context tokens are used around a mask token to predict what the mask token should be.

6. The method of claim 1, wherein the TDM is a sentence-level task where a global classification token of a last layer is used to predict whether an input product title matches a product description.

7. The method of claim 1, wherein the gating network adjusts weights according to input product content.

8. A non-transitory computer-readable storage medium comprising a computer-readable program for employing a knowledge-driven pre-training framework for learning product representation, wherein the computer-readable program when executed on a computer causes the computer to perform the steps of:
learning contextual semantics of a product domain by a language acquisition stage including a context encoder and two language acquisition tasks;
obtaining multi-faceted product knowledge by a knowledge acquisition stage including a knowledge encoder, skeleton attention layers, and three heterogeneous embedding guided knowledge acquisition tasks;
generating local product representations defined as knowledge copies (KC) each capturing one facet of the multi-faceted product knowledge; and
generating final product representation during a fine-tuning stage by combining all the KCs through a gating network.

9. The non-transitory computer-readable storage medium of claim 8, wherein the KCs are trained by the three heterogeneous embedding guided knowledge acquisition tasks to obtain the multi-faceted product knowledge.

10. The non-transitory computer-readable storage medium of claim 8, wherein the three heterogeneous embedding guided knowledge acquisition tasks are neighbor prediction, attribute prediction, and category prediction.

11. The non-transitory computer-readable storage medium of claim 8, wherein the two language acquisition tasks include a masked language model (MLM) and title description matching (TDM).

12. The non-transitory computer-readable storage medium of claim 11, wherein the MLM is a fill-in-the-blank task where context tokens are used around a mask token to predict what the mask token should be.

13. The non-transitory computer-readable storage medium of claim 8, wherein the TDM is a sentence-level task where a global classification token of a last layer is used to predict whether an input product title matches a product description.

14. The non-transitory computer-readable storage medium of claim 8, wherein the gating network adjusts weights according to input product content.

15. A system for employing a knowledge-driven pre-training framework for learning product representation, the system comprising:
a memory; and
one or more processors in communication with the memory configured to:
learn contextual semantics of a product domain by a language acquisition stage including a context encoder and two language acquisition tasks;
obtain multi-faceted product knowledge by a knowledge acquisition stage including a knowledge encoder, skeleton attention layers, and three heterogeneous embedding guided knowledge acquisition tasks;
generate local product representations defined as knowledge copies (KC) each capturing one facet of the multi-faceted product knowledge; and
generate final product representation during a fine-tuning stage by combining all the KCs through a gating network.

16. The system of claim 15, wherein the KCs are trained by the three heterogeneous embedding guided knowledge acquisition tasks to obtain the multi-faceted product knowledge.

17. The system of claim 15, wherein the three heterogeneous embedding guided knowledge acquisition tasks are neighbor prediction, attribute prediction, and category prediction.

18. The system of claim 15, wherein the two language acquisition tasks include a masked language model (MLM) and title description matching (TDM).

19. The system of claim 18, wherein the MLM is a fill-in-the-blank task where context tokens are used around a mask token to predict what the mask token should be.

20. The system of claim 15, wherein the TDM is a sentence-level task where a global classification token of a last layer is used to predict whether an input product title matches a product description.
